(19) United States
(12) Patent Application Publication
(10) Pub. No.: US 2005/0240526 A1
(43) Pub. Date: Oct. 27, 2005

(54) Automated financial service system

(75) Inventor: Mark A. Hill, Houston, TX (US)

Correspondence Address: OSHA LIANG L.L.P., 1221 MCKINNEY STREET, SUITE 2800, HOUSTON, TX, 77010, US

(73) Assignee: PayCenters, LLC, Houston, TX (US)

(21) Appl. No.: 11/114,738

(22) Filed: Apr. 26, 2005

Related U.S. Application Data
(60) Provisional application No. 60/565,317, filed on Apr. 26, 2004.

(51) Int. Cl. G06F 17/60

(52) U.S. Cl. 705/40; 705/39

(57) ABSTRACT

An automated financial service system including a client device configured to obtain bill payment information for a bill payment, wherein bill payment information includes user identification, merchant identification information, account information, and an amount paid, a transaction center operatively connected to the client device configured to receive the bill payment information, determine a merchant associated with the bill payment from the bill payment information, obtain merchant payment information for the merchant, and a monetary exchange mechanism interposed between the merchant and the transaction center configured to process the bill payment using the bill payment information and the merchant payment information, wherein processing the bill information includes transferring funds associated with the bill payment to the merchant.

### CROSS-REFERENCE TO RELATED APPLICATIONS

This application claims benefit of provisional application Ser. No. 60/565,317 filed on Apr. 26, 2004.

### BACKGROUND

Before the Internet, the typical method to perform a transaction with a merchant was to go to the physical location of the merchant and perform the transaction there, call the merchant, or mail the required documents, including payment, for the transaction to the merchant. Since the proliferation of the Internet, most merchants (e.g., Energy companies, Cable companies, Internet Service Providers, Credit Card companies, Financial Institutions, etc.) now offer consumers the ability to interact on-line access to their account information as well as perform certain financial transactions on-line. These transactions may include, online payment capabilities, e-mail payment reminders, balance transfers, etc. Thus, with a bank account and Internet access, a person is able to readily perform on-line transactions with a merchant.

However, many individuals do not use the Internet to perform financial transactions. This may be due to lack of Internet access or a trust in the ability of current security measures (e.g., encryption, passwords, etc.) implemented by the merchants when performing various on-line transactions, these security measures may include, for example, keeping the individual's personal information (e.g., bank account numbers, etc.) confidential. As a result, these individuals often perform their financial transactions by sending and receiving checks via the postal service.

Additionally, there are many individuals that do not have bank accounts. Thus, even if these individuals have Internet access, they would not be able to perform on-line transactions with a merchant. Having recognized that individuals without bank accounts still require a mechanism to perform financial transaction, a number of companies have provided financial services such as allowing individuals to transfer money to a merchant by giving cash directly to a retail location and the retail location sending the funds to the appropriate recipient. These charge the individuals a service fee for transferring the funds. Examples of such companies include Payday lenders, Western Union/Travelers, and pawn shops. Another option for individuals without bank accounts perform the aforementioned financial transactions is to use third-party checks, such as, money orders.

### SUMMARY

In general, in one aspect, the invention relates to an automated financial service system that includes a client device configured to obtain bill payment information for a bill payment, wherein bill payment information includes user identification, merchant identification information, account information, and an amount paid, a transaction center operatively connected to the client device configured to receive the bill payment information, determine a merchant associated with the bill payment from the bill payment information, obtain merchant payment information for the merchant, and a monetary exchange mechanism interposed between the merchant and the transaction center configured to process the bill payment using the bill payment information and the merchant payment information, wherein processing the bill information includes transferring funds associated with the bill payment to the merchant.

In general, in one aspect, the invention relates to an automated financial service method that includes obtaining bill payment information for a bill payment via a client device, the bill payment information includes user identification, merchant identification information, account information, and an amount paid, determining a merchant associated with the bill payment from the bill payment information, obtaining merchant payment information for the merchant, and processing the bill payment by a monetary exchange mechanism using the bill payment information and the merchant payment information, wherein processing the bill information includes transferring funds associated with the bill payment to the merchant.

In general, in one aspect, the invention relates to an automated financial service system that includes a client device configured to accept currency, obtain bill payment information for a bill payment, wherein bill payment information includes user identification, merchant identification information, account information, and an amount paid in currency, and output change, obtain stored value card information for a stored value card, wherein the stored value card information includes merchant identification information associated with the stored value card, an amount paid associated with the stored value card, and output a stored value card, a transaction center operatively connected to the client device configured to receive the bill payment information, determine a merchant associated with the bill payment from the bill payment information, obtain merchant payment information for the merchant, receive the stored value card information, determine a merchant associated with the stored value card from the stored value card information, obtain merchant payment information associated with the stored value card for the merchant associated with the stored value card, and a monetary exchange mechanism interposed between the merchant and the transaction center configured to process the bill payment using the bill payment information and the merchant payment information, wherein processing the bill information includes transferring funds associated with the bill payment to the merchant using an electronic transfer mechanism, and process the stored value card using the stored value card information and the merchant payment information associated with the stored value card, wherein processing the stored value card includes transferring funds associated with the stored value card to the merchant associated with the stored value card using an electronic transfer mechanism upon use of the stored value card.

Other aspects of the invention will be apparent from the following description and the appended claims.

### BRIEF DESCRIPTION OF DRAWINGS

FIG. 1 shows a system for managing a transaction in accordance with an embodiment of the invention.

FIG. 2 shows a client device in accordance with an embodiment of the invention.

FIG. 3 shows a method for processing a financial transaction in accordance with an embodiment of the invention.

FIG. 4 shows a method of processing a billing service request in accordance with an embodiment of the invention.

FIG. 5 shows a method of processing an ATM service request in accordance with an embodiment of the invention.

FIG. 6 shows a method of processing a stored value card service request in accordance with an embodiment of the invention.

### DETAILED DESCRIPTION

Exemplary embodiments of the invention will be described with reference to the accompanying drawings. Like items in the drawings are shown with the same reference numbers. Further, the use of “ST” in the drawings is equivalent to the user of “Step” in the detailed description below.

In the embodiments of the invention described herein, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and apparatus servicing financial transactions. Additionally, embodiments of the invention provide a method and apparatus enabling a user to perform a transaction with several entities (e.g., merchants) at a location that is remote to the entity.

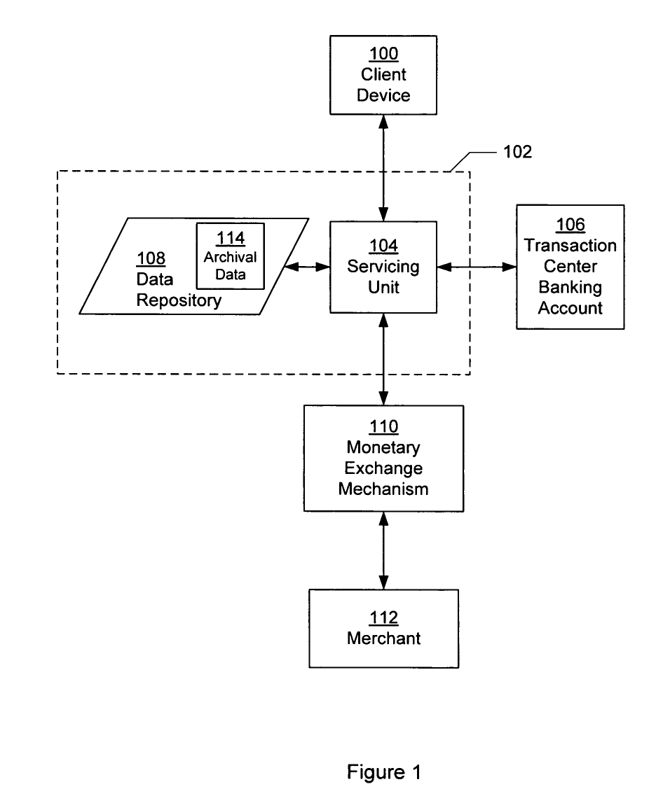

FIG. 1 shows a system for managing a transaction between a client device (100) and a merchant (112) in accordance with an embodiment of the invention. As shown in FIG. 1, the client device (100) is operatively connected to a transaction center (102) via a servicing unit (104). In addition to the servicing unit (104), the transaction center (102) also includes a data repository (108). In one or more embodiments of the invention, the transaction center (102) also includes a transaction center bank account (106). The servicing unit (104) is operatively connected to the data repository (108), the transaction center bank account (106) (i.e., a bank account that is associated with the transaction center (102) and is used to temporarily store funds received from the client devices (100) and the monetary exchange mechanism (110)), and a monetary exchange mechanism (110). Finally, the monetary exchange mechanism (110) is operatively connected to one or more merchants (112).

In accordance with an embodiment of the invention, the client device (100) provides an interface between the user and the rest of the system shown in FIG. 1. More specifically, the client device (100) includes an interface that allows a user to obtain account information about an account with a specific merchant, pay an outstanding bill, perform an ATM transaction (i.e., withdraw, deposit, or transfer funds), perform a transaction involving a stored value card, etc. Thus, the client device (100) includes functionality to request information from and display information to the user as well as receive funds from and disburse funds to the user. With respect to processing transactions, the client device (100) may include functionality to send the information, such as bill payment information, obtained from the user to the servicing unit (104) as soon as the information is entered. Alternatively, the information obtained from the user may be temporarily stored in the client device (100) until a specific time (or for a specific time period) or until the user has completed the transaction. In one embodiment of the invention, the client device (100) also includes functionality to monitor its own status (i.e., functioning properly, malfunctioning, etc.) and upon malfunction, send an alarm, such as paging, error alert, print out, notification email, etc., to the transaction center (102).

In one embodiment of the invention, the client device takes the form of a kiosk. Further, the client device (100) may be located at any location that includes the necessary infrastructure to allow the client device (100) to communicate with the transaction center (102). For example, the client device (100) may be located in a government building, a retail location, a park, etc.

The servicing unit (104) includes functionality to interact with the client device (100), the data repository (108), the transaction center bank account (106) and the monetary exchange mechanism (100). In one embodiment of the invention the servicing unit may include functionality to monitor the data repository (108), the client device (100) the monetary exchange mechanism (110), and the servicing unit (104). For example, the servicing unit (104) may include functionality to check for malfunctions or to look up historical data for billing anomalies or reconciliation. Further, the servicing unit (104) may include functionality to receive data from the monetary exchange mechanism (110). In one embodiment of the invention, the servicing unit (104) corresponds to one or more interconnected servers that include functionality to interact with the aforementioned components in the system. In one embodiment of the invention, if the servicing unit (104) corresponds to multiple servers, then each of the servers may be configured to perform certain functions. For example, one or more servers in the servicing unit (104) may be configured to transfer information between the data repository (108) and the client device (100), while another server or group of servers manages malfunction notifications from the client devices (100). Those skilled in the art will be able to appreciate that while this invention has been describe with one configuration of servers, alternative configurations are also possible.

Those skilled in the art will appreciate that the transaction center may be implemented using one or more servers. Further, the data repository may be implemented on the same server as a server in the servicing unit.

In one embodiment of the invention, a firewall surrounds the transaction center (102) and the transaction center banking account (106) and the applications executed on the client device (100). The presence of the firewall limits ability of unauthorized entities from accessing either the servicing unit (104) or the client devices (100). In one embodiment of the invention, the data communicated between the client devices (100) and the servicing unit (104) is also encrypted. The encryption ensures information communicated between the client device (100) and the servicing unit (104) is kept confidential.

In one embodiment of the invention, prior to adding a new client device (100) to the system, the transaction center (102) determines a desirable location for the new client device (100). In one embodiment of the invention, the transaction center determines a desirable location for the new client device by performing a cost-benefit analysis for the new client device at a various locations. The cost-benefit analysis includes gathering demographic data such as the hours of operation for the neighboring retailers or the retailers where the client device may potentially be located. Once a location is selected, the new client device (100) is installed at the location and operatively connected to the transaction center (102). Once connected, the transaction center (102) obtains information about the new client device (e.g., location of the client device, etc.) and stores this information in the data repository (108). In addition, the transaction center (102) may provide various encryption keys, etc. to allow the new client device (100) to securely interact with the transaction center (102). After the new client device has been successfully integrated, the transaction center (102) verifies that the new client device is operating correctly before being accessible to the users.

In one embodiment of the invention, the servicing unit (104) also includes functionality to update the data repository (108) with information associated with the transactions that are being performed. In one embodiment of the invention, the servicing unit (104) updates that data repository (108) in a manner that enables the data repository (108) to maintain a real-time record of the aggregate credits and debits between the merchant (112) and the client device (100). In addition to maintaining transaction information, the data repository (108) also maintains data about the client devices (100), the merchants (112), and users.

In one embodiment of the invention, the data repository (108) may also include information about the physical address associated with particular merchants (112) as well as information about the physical address of the client devices (100). The address information may be used to determine which merchants (112) are located in the same geographical area as the client device (100). For example, the merchant (112), may only be located in specific geographic regions. In this scenario, the address information for the merchant (112) and the client device (100) are used to determine which merchants (112) the user of the client (112) can interact with (i.e., the user, in some implementations, may only interact with merchants in the same geographic area). Further, the address information may be used, for example, to determine to which address, if the merchant has multiple addresses, to send the payment. For example, certain merchants require that transactions from one region (i.e., geographic area) are sent to an office or account for the merchant (112) that is associated with that region. Thus, when a user makes a bill payment from a client device (100) located in a specific geographic region, the funds may be forwarded to the correct office and/or account for the merchant (112) in that geographic area.

In one embodiment of the invention, the data repository (108) may be implemented as a set of files, a spreadsheet, a hierarchical and/or a relational database, a transactional database, or any other storage mechanism for data. In an embodiment of the invention, the data repository (108) contains archival data (114) as well as current data. The archival data (114) is used to keep track of past transactions, ensure the system stability, and return funds to a user in the case of a refund results from a past transaction.

In addition to forwarding information about transactions to the data repository (108), the servicing unit (104) also includes functionality to transfer funds to the transaction center bank account (106) received from the client device (100) and the monetary exchange mechanism (110), functionality to transfer from the transaction center bank account (106) to the monetary exchange mechanism (110), functionality to transfer funds from the monetary exchange mechanism (110) to the transaction center back account (106), and functionality to transfer funds from the transaction center bank account (106) to the client device (100).

In one embodiment of the invention, the monetary exchange mechanism (110) is used to transfer payments and data between the transaction center (102) and the merchant (112). More specifically, the monetary exchange mechanism (110) corresponds to a system or an interface into a system that provides functionality to transfer funds and data for audit trails from the transaction center (102) to the appropriate merchant (112). For example, the monetary exchange mechanism (110) may be implemented as an originator for any type of electronic transfer mechanism (i.e. Automated Clearing House (ACH), Electronic Funds Transfer (EFT), Electronic Benefit Transfer (EBT), etc.). The monetary exchange mechanism may also be implemented through a subscriber service which manages credit, debit, stored value card, and other such transactions. Thus, the monetary exchange mechanism (110) may send a request to transfer funds over the electronic transfer mechanism network. The electronic transfer mechanism network in turn includes functionality to transfer the funds (as specified in the request) to the appropriate merchant (112). Those skilled in the art will appreciate that when funds are transferred to a merchant (112) that the funds are transferred to a bank account associated with the merchant (112).

In one embodiment of the invention, the monetary exchange mechanism (110) may be included as part of the transaction center (102). Further, in one embodiment of the invention, the monetary exchange mechanism (110) may include functionality to process the transactions in real-time (e.g., transfer funds to the merchant (112) in real-time).

Those skilled in the art will be able appreciate that while this system has been described with respect to a traditional central server architecture, the system may also be implemented using a peer-to-peer mechanism. In such cases, each client device (100) is responsible for sending transaction records directly to the monetary exchange mechanism (110). Further, the client device (100) communicates with other client devices (not shown) in order to maintain a list of merchants (112) and users.

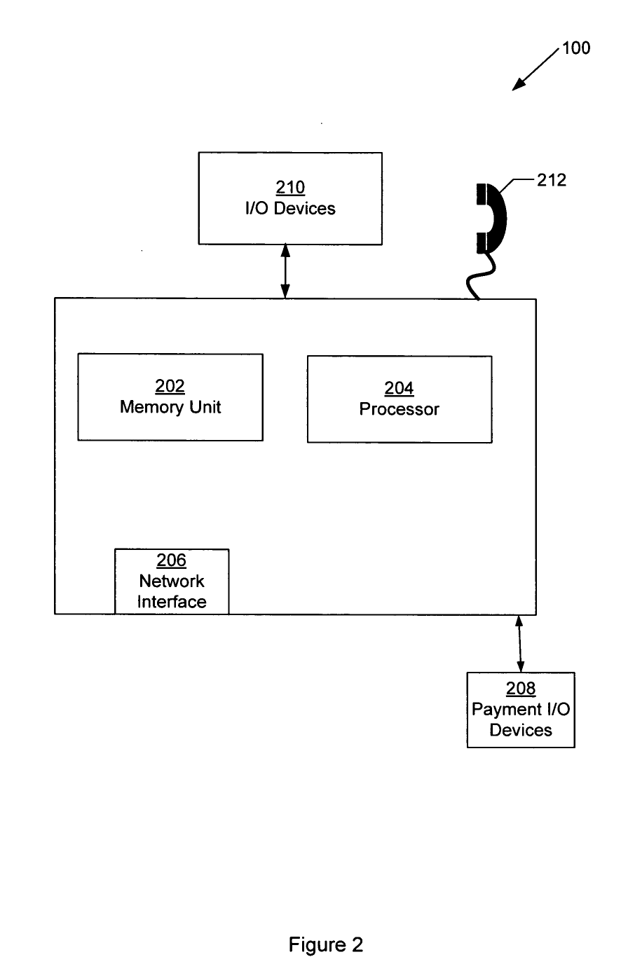

FIG. 2 shows the client device (100) in accordance with an embodiment of the invention. The client device (100) includes a memory unit (202), a processor (204), a network interface (206), a payment input/output device (208), a data input/output device (210), and a telephone (212). Each of these components is discussed below.

In one embodiment of the invention, the memory unit (202) stores information received from and sent to the network interface (206) as well as information from input and output from the I/O device (210) and the payment I/O device (208). In addition, the memory unit (202) may also include information about the physical address of the client device (100) as well be configured to store temporary information resulting from the processing of requests by the processor (204). In one embodiment of the invention, the information received from the network interface (206) includes eXtensible Markup Language (XML) encoded pages or pages written in another computer language from a servicing unit (104).

The memory unit (202) may be implemented using random access memory (RAM) which stores that information in the pages temporarily until they are sent via the network interface (206) or removed from the memory unit (202). Alternatively, the memory unit (201) may also have more stable storage (e.g., a hard drive) to persistently store programming instructions (e.g., executable code, byte code, etc.) that are executed by the processor (204) to provide the user with the functionality discussed above. As an alternative, programming instructions may also be stored in Read Only Memory (ROM).

In an embodiment of the invention, the client device (100) may also retrieve data from an archival data (114) of some or all transactions performed through the transaction center (102) and temporarily storing the data in the memory unit (202). This archival data (114) is used to maintain records and allow for auditing and/or verification of previously executed transactions.

Continuing with the discussion of FIG. 2, the I/O devices (210) act as the interface between the user and the client device (100). One example of an I/O device (210) is a touch screen. In one embodiment, the touch screen displays a graphical user interface to the user and receives input (e.g., requests to perform transactions) from the user by allowing the user to physically touch portions of the touch screen. In one embodiment of the invention, graphical user interface provide several screens that guide the user through a transaction. The graphical user interface may use information images and buttons along with both text and audio queues. In addition to or as an alternative to the touch screen that client device (100) may also include one or more of the following I/O devices: a keyboard, a mouse, a trackball, a biometric scanner, a printer, navigational buttons, devices to process voice recognition and response, a second display device for advertising, such as a large plasma screen, LED display, or motion display, a camera, fingerprint scanner, etc.

In one embodiment of the invention, the payment I/O devices (208) may include, but are not limited to, a currency acceptor and dispenser, a scrip reader, card reader, scanners and dispensers for cards (e.g., debit cards, credit cards, stored valued cards, welfare cards, gift cards), a check scanner, a scanner, a bar code readers for reading information off of documents involved in a transaction supported by the client device (100). Further, the client device may also include a card writer. For example, the card writer may include functionality to encode data in a bar code format or magnetic strip on card stock, or printed (embossed on the card stock. Those skilled in the art will be able to appreciate that there are multiple mechanisms of payment and different devices for reading, inputting, and outputting the various methods of payment. Accordingly, the scope of the invention is not intended to be limited to those mechanisms of payment stated above.

In one embodiment of the invention, the client device (100) includes a telephone (206) that is connected to a help desk. Further, the client device (100) may be configured to allow the help desk personnel to take control of the client device (100) and assist the user in completing the transaction. In some instances, the help desk personnel may enter the content remotely on behalf of the user. In such cases, the client device (100) may be configured to allow the user to watch on the screen of the client device (100) as the help desk personnel performs the transaction on behalf of the user. This allows the user to learn how to perform the transaction for future uses. In one embodiment of the invention, the help desk and client device includes a camera and a viewing panel on the monitors. This allows the user and the help desk personnel to see each other as the help desk personnel assists the user.

In one embodiment of the invention, the client device (100) includes functionality to monitor itself. Thus, if any part of the client device (100) is malfunctioning, such a broken I/O device, out of change, printer out of paper error, or an open payment I/O device, then the client device sends a notification (e.g., an email, page, alert on a help desk, an audible error tone, etc.) through the network interface (206) to a servicing unit (104) notifying the service unit of the error.

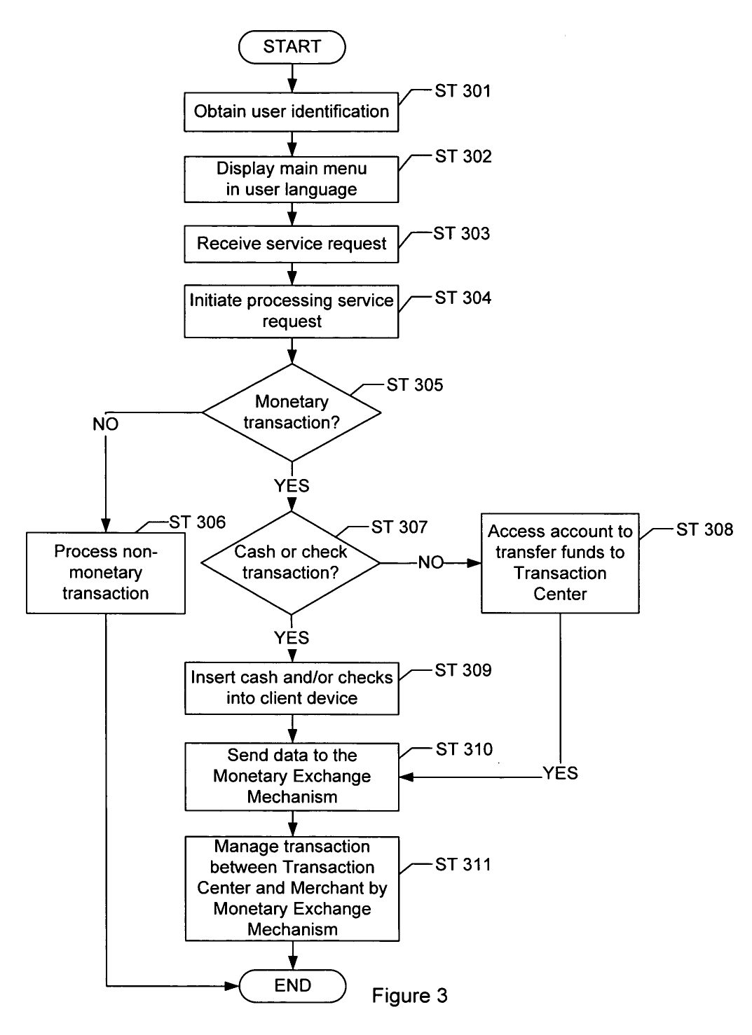

FIG. 3 shows a method for processing a financial transaction in accordance with an embodiment of the invention. Initially, the client device obtains user identification (ST301). There are several mechanisms for a user to identify themselves. For example, the first time a user accesses a client device, the user may register (described below) with the transaction center. This information is then stored in the data repository within the transaction center. In one embodiment of the invention, registration includes providing information such as name of the user, user's addresses, and phone number, and other personal information such as a birth date, social security number, and/or driver's license number. During registration the user may also enter a personal identification number (PIN) in order to authenticate themselves to the client device. As an alternative to inputting the above information, the user may register themselves by swiping an identification card such as a driver's license, passport, etc. through a card reader. As another alternative, the user may enter their name along with some form of biometric data such as a fingerprint. Those skilled in the art will appreciate that the client device will include the aforementioned I/O devices to obtain the information necessary for registration.

By registering with the transaction center, the user is then able to identify themselves to the client device on subsequent occasions. For example, a returning user, may identify themselves through the use of the pin number, a card encoded with their data, etc. Further, the registration allows the transaction center to track the usage of the user, store a financial history, provide customizable features, and derive data for future usage (e.g. store credit card information or merchants the user has previously requested for future transactions). As an alternative to registering the user (or in the case where the user does not want to be tracked), the client device may ask the user to merely input information necessary to identify the individual (i.e., a name). Those skilled in the art will appreciate that certain transactions do not require the user identify themselves. In such cases ST301 is not performed (or required to be performed).

Continuing with the discussion of FIG. 3, once the user has been identified (either with or with registration), the client device displays a main menu, in the user's language of choice, that includes a listing of transactions that the user may perform using the client device (ST302). Though not shown in FIG. 3, in one embodiment of the invention, the client device may first request the language of the user in order to display output in a user appropriate language or, alternatively, the national language of the country where the client device is located is used or the client device displays the instructions in several different languages. Those skilled in the art will appreciate that if the user is blind, the client device may use a speaker or other means to convey the information in the menu to the user. According to one embodiment of the invention, the display output in a language the user had previously requested. These transactions may include, but are not limited to, transactions to manage user accounts, transactions to pay an outstanding bill, ATM transactions (i.e., withdraw, deposit, or transferring finds), transactions involving a stored value card (e.g., creating a stored value card, issuing a replacement stored value card, etc.), transactions involving other banking services (e.g., receiving payroll, issuing money orders), transaction involving incentive programs (i.e., programs designed to encourage the usage of the client devices), etc. Those skilled in art will appreciate that the services (i.e., transactions that a user may perform using the client device) discussed above are not intended to be limited to those stated above.

Continuing with discussion of FIG. 3, the client device receives a request for performing a service (i.e., a service request) from the user (ST303). Upon receipt of the service request, the client device initiates processing the service request (ST304). In one embodiment of the invention, initiating the processing of the service request includes obtaining the merchant identification information and account information as applicable. In one embodiment of the invention, merchant identification information may include information necessary to identify the merchant (e.g., merchant's name, unique ID associated with the merchant, etc.). The merchant identification information may be obtained by manually inputting the merchant identification information into the client device by the user, selecting the merchant from a list of merchants, etc. In one embodiment of the invention, as the user is inputting merchant identification information, the merchant identification information is verified by the merchant information in the data repository. If the merchant identification information cannot be verified, then the user may input information derived from the merchants invoice or billing address information for the merchant. This allows the user to pay any bill electronically, including paying a single person or small business not associated with the monetary exchange mechanism or transaction center. In one embodiment of the invention, account information corresponds to information about the specific account that the user has with the particular merchant.

Continuing with the discussion of FIG. 3, the client device subsequently determines whether the service request is a transaction that involves the transfer of funds (i.e., a monetary transaction) between the client device and the user (ST305). If the transaction is not a monetary transaction, such as checking the status of various accounts, then the client device processes the non-monetary transaction (ST306).

Alternatively, if the transaction is a monetary transaction, then the client device determines, using information from the user, whether the transaction involves a cash or check (i.e., a cash or check transaction) (ST307). If the transaction is cash or check transaction, then the user inputs cash and/or checks into the client device (ST309). Those skilled in the art will appreciate that inputting the check or cash into the client device with result in pending credit to the transaction center bank account (i.e., the funds will appear to be in the transaction bank account for the purposes of allowing the transaction center and the monetary exchange mechanism to conduct the transaction).

If the transaction is not a cash or check transaction (i.e., the transaction is an electronic transaction (e.g., a transaction involving the transfer of funds from one account of the user to another account that is owned or not owned by the user), then the client device obtains account information and through the transaction center transfers funds from the user's account to the transaction center bank account (ST308).

Regardless, of whether the transaction is a cash or check transaction electronic, credit card or stored value card transaction, the required data to complete the transaction is sent to the monetary exchange mechanism (ST310). In one embodiment of the invention, the required data to complete the transaction includes merchant identification information, account information, information about the transaction center bank account (if necessary), etc. The monetary exchange mechanism, upon receiving the aforementioned data, manages the transaction between the transaction center and the merchant (ST311). In one embodiment of the invention, managing the transaction may include transferring the appropriate funds from the transaction center bank account to the merchant.

In an embodiment of the invention, the servicing unit compiles the aggregate debits or credits between the transaction center and the merchants associated with the third-party aggregator/consolidator gateway solution and stores the information into a file with a listing of the users payments. This file is transferred at a set time to the third-party aggregator/consolidator gateway solution. Alternatively, if there are several servers, each server sends a file to the third-party aggregator/consolidator gateway solution. The third-party aggregator/consolidator gateway solution sets up batch processing of all files into the electronic transfer mechanism. The third-party aggregator/consolidator gateway solution gathers the required funds to pay for the aggregate debits or credits from the transaction center bank account and transfers the funds to the merchants. The transfer mechanism may be through the electronic transfer mechanism network and informs the merchants of the user transactions. The third-party aggregator/consolidator gateway solution sends acknowledgement of the transfers to the servicing unit. In one embodiment of the invention, for validation purposes, if there are no transactions to report from a server, than a file is sent to the third-party aggregator/consolidator gateway solution with an empty header. Thus, if a file is not sent to the third-party aggregator/consolidator gateway solution, then the third-party aggregator/consolidator gateway solution will query the server to request the file. If the third-party aggregator/consolidator gateway solution still does not receive a response, then the third-party aggregator/consolidator gateway solution logs a no file transmission and sends an email to the transaction center of an error. In an embodiment of the present invention, the merchant may operate directly with the Transaction Center. In which case, the Transaction Center sends a file containing the aggregate debits and credits due to the merchant along with information about the users requesting the transactions. A transaction is then processed directly between the transaction center bank account and the merchant. The aforementioned functionality allows the transaction center to perform the transactions as a batch.

In one or more embodiments of the invention, the electronic transactions are processed using the electronic transfer mechanism network directly. Thus, these transactions are performed in real-time. Namely, as the transaction is being performed between the user and the transaction center, the transaction is also being performed between the transaction center and the merchant.

In one or more embodiments of the invention, the monetary exchange mechanism may use a person-to-person method of payment. For example, if the merchant identification information inputted by the user cannot be verified with the merchant information in the data repository, then the monetary exchange mechanism may first validate the information, to ensure the merchant information is not in an alternate form, before sending payment to the merchant information inputted by the user.

In one or more embodiments of the invention, if the transactions is a credit card, or stored value card transaction, then the monetary exchange mechanism may be a subscriber service associated with the transaction center. In which case the subscriber service performs the transaction. For example, as the credit card or stored value card information may be sent to the transaction center where the information is forwarded to the subscriber service. The subscriber service validates the card and the user before sending the user-authorized payment directly to the merchant. In accordance with one embodiment of the invention, the subscriber service may also forward the transaction fee to the transaction center banking account.

In one or more embodiments of the invention, the monetary exchange mechanism is a part of the transaction center. Further, the monetary exchange mechanism may then perform the functions of the third-party aggregator/consolidator.

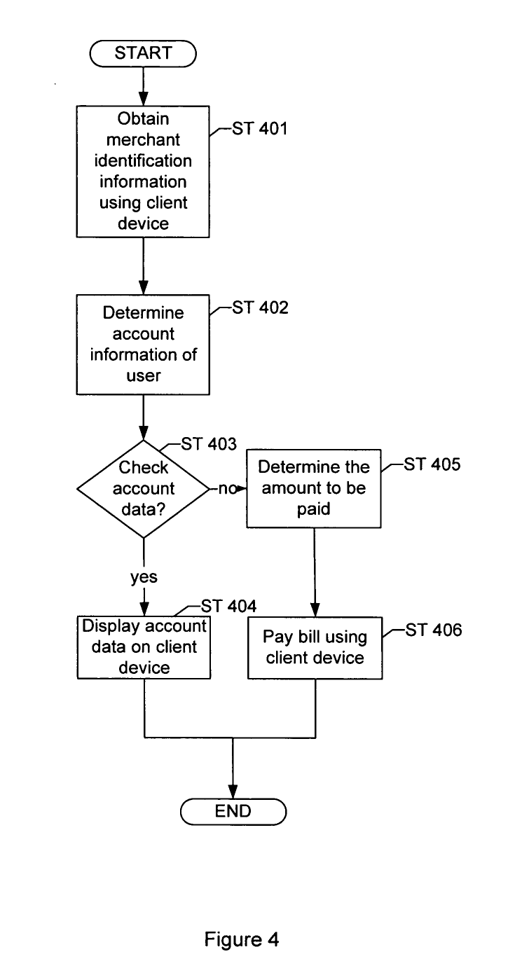

FIGS. 4 though 6 illustrate how the system initiates processing, and performs the transaction between the user and the system for three of the possible service requests in accordance with an embodiment of the present invention.

FIG. 4 shows a method for processing a billing service request between the user and the system in accordance with an embodiment of the invention. Initially, the system obtains merchant identification information from the user, via the using the client device (ST401). As discussed above, there are several mechanisms for a user to input the merchant identification information. The account information of the user is subsequently determined (ST402). The account information may be input manually by the user or obtained via one of the above mentioned I/O devices.

As an alternative to ST401 and ST402, if the user is a returning user, then the client device displays the merchants that the user has requested in the past, for example, using information from the client device or information from the transaction center. The user then specifies with which merchant the transaction is associated. In the data repository of the transaction center is the account information of the user. Thus, the user does not need to specify the account information.

Alternatively, the bill may have a computer readable code. In this case, the user scans the bill into the client device. The merchant identification information and account information are all encoded in the bill. Another alternative, the client device may receive the bill from the merchant for the particular user and the user identifies the received bill to be paid.

Once the information from ST401 and ST402 (or an alternative) has been obtained, the client device determines whether the user wants to check their account data. The user may wish to access their account to change their personal information, or keep track of the amount of the bill. If the user wants to check the account data, then, the account data is displayed on the client device (ST404). At this time, the client device may also allow the user to input updates that are subsequently forwarded to the merchant (not shown).

If, however, the user does not wish to check the account data (i.e., the user only wishes to pay the bill at this time), then the client device determines the amount that the user wants to pay (typically by querying the user) (ST405). In one embodiment of the invention, the user may pay all or part of the bill. The user pays the bill using the client device (ST406). There are several mechanisms for the user to pay the bill. The user may pay by currency, foreign and domestic, such as dollars and coins. In accordance with an embodiment of the invention, when inputting the currency, the client device displays the amount which was paid and the last amount inputted. Alternatively, the user may pay using a stored-value-card which was issued by the client device. As another alternative, the user may pay by debit or credit cards, electronic transfers from their bank account, with a check through a check reader, or other electronic methods.

When the user has inputted the amount, if there is change due to the user, then the client device will output the change. Change may be in the form of currency, money order, a donation to a philanthropic endeavor, loaded into a debit card account, loaded into a stored value card account, or scrip. Scrip allows the user to pay the next bill with the client device or to buy goods, services or redeem such as at a neighboring retail location. When the user has received the change, they may pay another bill, or receive another financial service. When the user has finished using the client device, then the client device prints a receipt of all of the transactions performed and the user logs out. Before the user logs out of the client device, the client devices collects data about the transaction to use for user trending analysis and requests that the user fill in a survey.

As the client device has obtained and transferred to the transaction center the user identification, the merchant identification information, the account information, and the amount paid, the client device has transferred the bill payment information required to process the transaction between the transaction center and the merchant. Once the bill payment information arrives at the transaction center, the transaction center determines the merchant from bill payment information. This may include determining how to process the payment the particular merchant. For example, certain merchants may be associated with a third-party aggregator consolidator gateway solution, while other merchants are associated only with the transaction center. Further, certain merchants may have separate billing addresses or payment accounts to use depending on the location of the client device. Therefore, the servicing unit gathers from the data repository the merchant payment information which details how to process the transaction for that merchant given the location of the client device. The servicing unit uses the monetary exchange mechanism to process the transaction using the bill payment information and the merchant payment information.

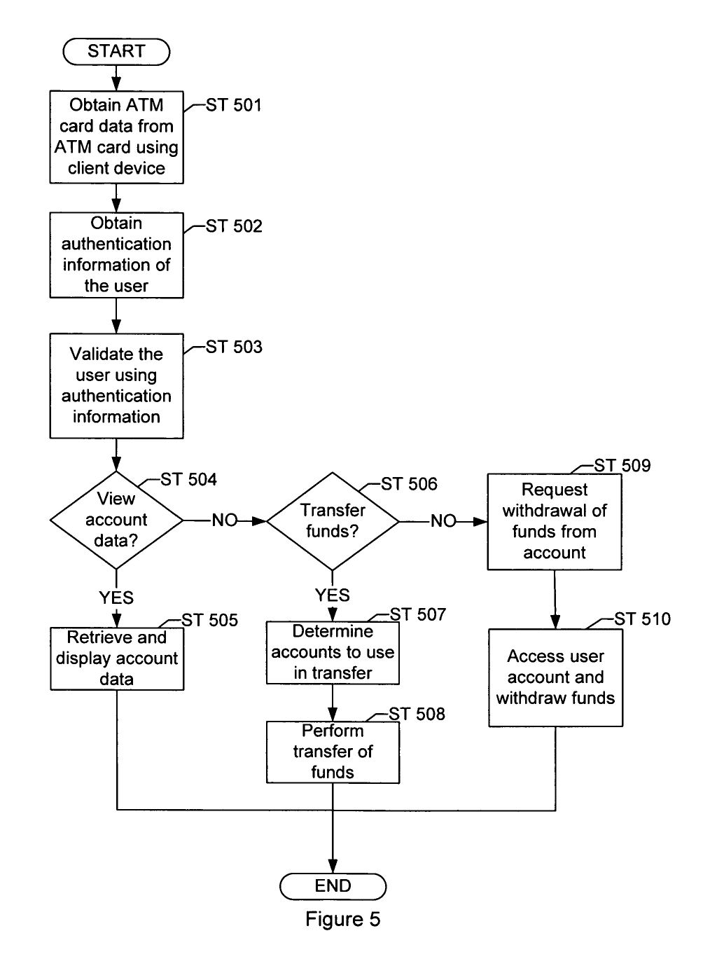

FIG. 5 shows a method for processing an ATM service between the user and the system in accordance with an embodiment of the invention. Initially, the system obtains an ATM card data using the client device (ST501). The user may manually type in the card information or input the ATM card using a card reader. The client device subsequently obtains authentication information of the user (ST502). This may be done through having the user input a PIN number, a fingerprint scan in which the fingerprint is associated with the card, etc.

The system then validates the user using the authentication information (ST503). In this step the system determines whether the information inputted by the user is correct for the card. This determination may involve contacting the entity that issued the card to determine whether the authentication information input by the user is valid. Once the ATM card has been validated, a determination is made about whether the user wants to view the account(s) associated with the ATM card (ST504). If the user wants to check the account data, then the account information is retrieved from the entities that is associated with the ATM card and subsequently displayed to the user via the client device (ST505).

If the user does not want to check their accounts, than the user may alternatively want to transfer funds (ST506). If the user wants to transfer funds, then the user inputs/selects the accounts to use in the transfer and the amount to transfer (ST507). The transaction center, using the information obtained in ST507, proceeds to perform the transfer of funds (ST508). Alternatively, the user may request to withdraw funds from their ATM account (Step 509). In such situations, the user is requested to specify an account and the amount of funds to withdraw from the account, and the transaction center, using the aforementioned information, withdraws the funds from the user's account and disperses the funds the user via the client device (ST510).

Those skilled in the art will be able to recognize that while only a limited number of ATM services have been described, there are several ATM services not listed that the system may perform without departing from the scope of the invention. Further, certain steps, common to the art and that are required in order to perform the transaction, have been omitted in order not to obscure the invention.

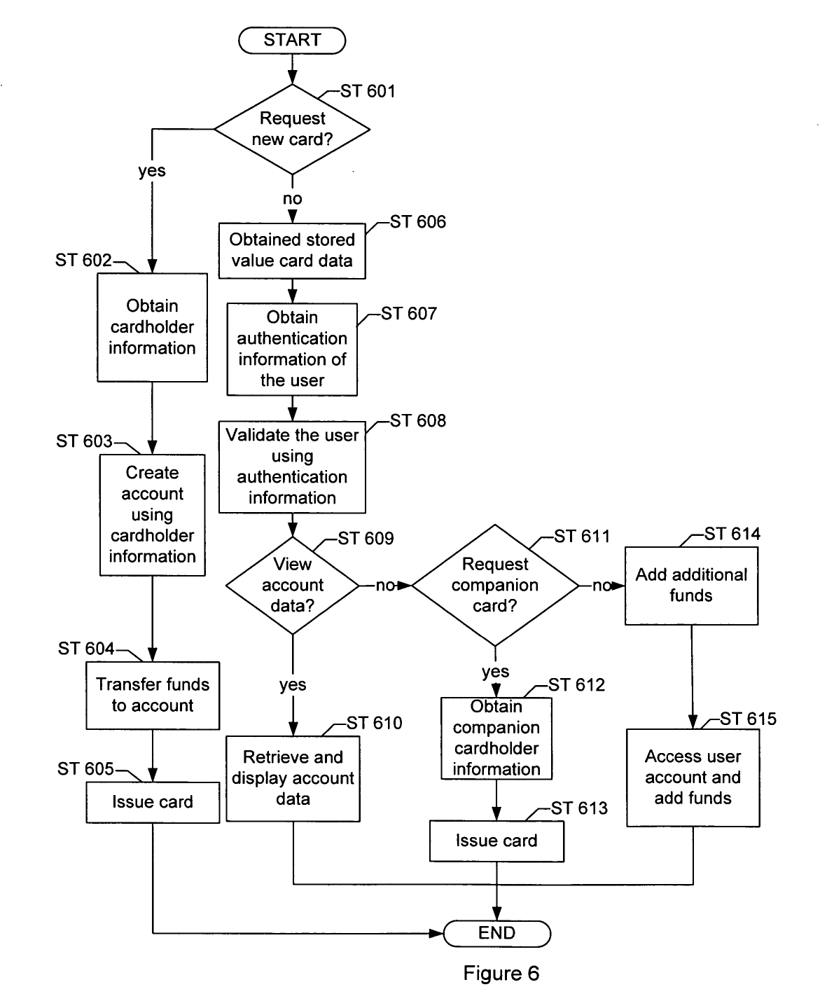

FIG. 6 shows a method for processing a stored value card service between the user and the system in accordance with an embodiment of the invention. Initially, a determination is made whether the user has requested a new stored-value card (ST601). If the user has requested a new stored-value card, then the transaction center obtains the cardholder information using one or more I/O devices associated with the client device (ST602). The client device sends to the transaction center information about the transfer (which typically includes an amount the user wishes to transfer to the stored-value card). Upon receipt of the aforementioned information, the transaction center creates an account (ST603) and transfers the funds to the merchant associated with the stored value card (ST604). The stored-value card, including information about the funds stored on the card, is issued to the user (ST605). In an embodiment of the invention, the card is mailed to the user. Alternatively, the client device may output a stored valued card encoded with the amount of funds the user requested.

As an alternative to requesting a new stored-value card, the user may desire to access their current stored-value card. In such cases, the data on the stored-value card is obtained using the client device (ST606). In one embodiment of the invention, the stored-value card information may be obtained manually or automatically by using, for example, a card reader. Authentication information associated with the stored-value card is subsequently obtained from the user via the client device. (ST607). The authentication information is subsequently validated by the transaction center, the client device, or a combination thereof (ST608).

Once the authentication information has been validates, a determination is made whether the user wants to view the account associated with the stored value card (ST609). If the user does want to view the account data, then the transaction center the account information associated with the stored value card and displays that information on the client device (ST610). Alternatively, if the user requests a companion card (ST611), then, then transaction center obtains the cardholder information (which may be different from the card information of the current user) from the user via the client device (ST612). Once the cardholder information has been obtained, then card is issued to the user (ST613). Those skilled in the art will appreciate that companion card issued in ST613 includes information about the amount of funds remaining on the card, etc. In an embodiment of the invention, the card is mailed to the user. Alternatively, the client device may output the companion stored valued card encoded.

Alternatively, the user may request to add additional funds to their stored value card (ST614). In such cases, the user inputs the amount of additional funds to input added to the stored value card and, either, provides an account that includes sufficient funds or inputs cash, a check, or a transfer of funds from an authorized checking account in the amount of the funds, or uses an alternate debit card or credit card to fund the stored value card, using the client device. The funds are subsequently added to the user account, and encoded on the stored value card of the user (ST614).

Those skilled in the art will be able to recognize that while only a limited number of stored valued card services have been described, there are several stored value card services not listed that the system may perform without departing from the scope of the invention. Further, certain steps, common to the art and that are required in order to perform the transaction, have been omitted in order not to obscure the invention.

One or more embodiments of the invention may have one or more of the following advantages. Embodiments of the invention allows users to pay bills efficiently without the use of a personal computer. Further, the user only needs to go to a single client device and pay bills for multiple merchants. Further, by allowing a user of the client device to effectively make an electronic payment, the processing transaction speed is reduced to only a few hours or days in comparison to many days or weeks. Also, with the easy to use interface and a help desk which may input the data on the part of the user as the user is watching, the user is not required to have knowledge of financial management, the use of computers, or the Internet. Embodiments of the invention give access to a segment of the population which would otherwise not have access. For example, users without bank accounts are able to build credit and have savings accounts. Thus, the automated financial service center system in accordance with embodiments of the invention described above enables users without bank accounts to obtain bank accounts. Finally, by having users go to a site provider's location, the automated financial service center encourages foot traffic at the site provider's location.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An automated financial service system comprising:
a client device configured to obtain bill payment information for a bill payment, wherein bill payment information comprises user identification, merchant identification information, account information, and an amount paid;
a transaction center operatively connected to the client device configured to:
receive the bill payment information;
determine a merchant associated with the bill payment from the bill payment information;
obtain merchant payment information for the merchant; and
a monetary exchange mechanism interposed between the merchant and the transaction center configured to process the bill payment using the bill payment information and the merchant payment information, wherein processing the bill information comprises transferring funds associated with the bill payment to the merchant.

2. The system of claim 1, wherein the client device is further configured to accept currency, and the bill payment information further comprises an amount of currency inserted into the client device.

3. The system of claim 1, wherein the transaction center comprises a data repository.

4. The system of claim 3, wherein the data repository is further configured to store merchant information and user information.

5. The system of claim 4, wherein the merchant information is used to determine the merchant associated with the bill payment and obtain merchant payment information.

6. The system of claim 4, wherein the user information comprises a financial history associated with the user identification.

7. The system of claim 1, wherein the client device is further configured to
obtain stored value card information for a stored value card, wherein the stored value card information comprises merchant identification information associated with the stored value card, an amount paid associated with the stored value card; and
output a stored value card,
the transaction center further configured to:
receive the stored value card information;
determine a merchant associated with the stored value card from the stored value card information;
obtain merchant payment information associated with the stored value card for the merchant associated with the stored value card; and
the monetary exchange mechanism further configured to: process the stored value card using the stored value card information and the merchant payment information associated with the stored value card, wherein processing the stored value card comprises transferring funds associated with the stored value card to the merchant associated with the stored value card upon use of the stored value card.

8. The system of claim 2, wherein the client device is further configured to output change when the amount of currency inserted into the client device is more than the amount paid.

9. The system of claim 8, wherein the change is at least one selected from the group consisting of: currency, a money order, a donation to a philanthropic endeavor, money loaded into a debit card account, money loaded into a stored value card account, and a scrip.

10. The system of claim 1, wherein the monetary exchange mechanism uses an electronic transfer mechanism.

11. The system of claim 1, wherein the monetary exchange mechanism is a third-party aggregator/consolidator gateway solution.

12. The system of claim 1, wherein the monetary exchange mechanism uses an Automated Clearing House (ACH) to transfer the funds to the merchant.

13. The system of claim 1, wherein the client device comprises an automated kiosk.

14. The system of claim 1, the transaction center comprises a data repository configured to store the merchant payment information.

15. The system of claim 1, wherein the merchant is associated a plurality of billing addresses and wherein the transaction center determines one of the plurality of billing addresses to use in the processing of the bill payment based on a geographical region of the client device.

16. The system of claim 1, wherein the client device comprises a touch screen to enable a user to input bill payment information.

17. The system of claim 1, wherein the client device comprises a screen for advertising.

18. The system of claim 1, wherein the client device comprises a communication device for connecting a user of the client device to a remote help desk.

19. The system of claim 18, wherein the remote help desk comprises functionality to control the client device.

20. The system of claim 1, wherein the client device comprises an error checking mechanism and if the error checking mechanism detects an error, the client device sends a notification of the error.

21. An automated financial service method comprising:
obtaining bill payment information for a bill payment via a client device, the bill payment information comprising user identification, merchant identification information, account information, and an amount paid;
determining a merchant associated with the bill payment from the bill payment information;
obtaining merchant payment information for the merchant; and
processing the bill payment by a monetary exchange mechanism using the bill payment information and the merchant payment information, wherein processing the bill information comprises transferring funds associated with the bill payment to the merchant.

22. The method of claim 21, further comprising accepting currency via the client device, wherein the bill payment information further comprises an amount of currency accepted.

23. The method of claim 21, wherein the monetary exchange mechanism is a third-party aggregator/consolidator gateway solution.

24. The method of claim 21, transferring the funds to the merchant comprises using an Automated Clearing House (ACH).

25. The method of claim 21, wherein an automated kiosk performs the obtaining the bill payment information and transferring the bill payment information to a transaction center.

26. The method of claim 21, further comprising storing the merchant payment information.

27. The method of claim 21, wherein the merchant is associated a plurality of billing addresses, the method further comprising determining one of the plurality of billing addresses to use in the processing of the bill payment based on a geographical region of the client device.

28. The method of claim 21, wherein a touch screen enables a user to input bill payment information to the client device.

29. The method of claim 21, further comprising displaying advertising.

30. The method of claim 21, further comprising connecting a user to a remote help desk.

31. The method of claim 30, further comprising controlling the client device from the remote help desk.

32. The method of claim 21, further comprising monitoring the client device for errors and, upon detection of an error, sending notification of the error.

33. The method of claim 21, further comprising storing merchant information and user information.

34. The method of claim 33, wherein the determining the merchant information associated with the bill payment and the obtaining merchant payment information uses the merchant information.

35. The method of claim 33, wherein the user information comprises a financial history associated with the user identification.

36. The method of claim 21, further comprising:
obtaining stored value card information, the stored value card information comprising merchant identification information, an amount paid; and
determining a merchant associated with a stored value card from the stored value card information;
obtaining merchant payment information associated with the stored value card for the merchant associated with the stored value card;
processing the stored value card using the stored value card information and the merchant payment information associated with the stored value card, wherein processing the stored value card comprises transferring funds associated with the stored value card to the merchant associated with the stored value card upon use of the stored value card.
outputting the stored value card,

37. The method of claim 22, further comprising outputting change when the amount of currency inserted into the client device is more than the amount paid.

38. The method of claim 37, wherein the change is at least one selected from the group consisting of: currency, a money order, a donation to a philanthropic endeavor, money loaded into a debit card account, money loaded into a stored value card account, and a scrip.

39. The method of claim 21, processing the bill payment comprises using an electronic transfer mechanism.

40. An automated financial service system comprising:
a client device configured to
accept currency;
obtain bill payment information for a bill payment, wherein bill payment information comprises user identification, merchant identification information, account information, and an amount paid in currency; and
output change;
obtain stored value card information for a stored value card, wherein the stored value card information comprises merchant identification information associated with the stored value card, an amount paid associated with the stored value card; and
output a stored value card,
a transaction center operatively connected to the client device configured to:
receive the bill payment information;
determine a merchant associated with the bill payment from the bill payment information;
obtain merchant payment information for the merchant;
receive the stored value card information;
determine a merchant associated with the stored value card from the stored value card information;
obtain merchant payment information associated with the stored value card for the merchant associated with the stored value card; and
a monetary exchange mechanism interposed between the merchant and the transaction center configured to process the bill payment using the bill payment information and the merchant payment information, wherein processing the bill information comprises transferring funds associated with the bill payment to the merchant using an electronic transfer mechanism; and
process the stored value card using the stored value card information and the merchant payment information associated with the stored value card, wherein processing the stored value card comprises transferring funds associated with the stored value card to the merchant associated with the stored value card using an electronic transfer mechanism upon use of the stored value card.
